(19) United States
(12) Patent Application Publication
(10) Pub. No.: US 2007/0116573 A1
(43) Pub. Date: May 24, 2007

(54) Fan and impeller thereof

(75) Inventors: Cheng-Shu Yu, Taoyuan Hsien (TW); Peng-Chu Tao, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/384,393

(22) Filed: Mar. 21, 2006

(30) Foreign Application Priority Data
Nov. 18, 2005 (TW) 094140584

(51) Int. Cl. B64C 11/00

(52) U.S. Cl. 416/182

(57) ABSTRACT

An impeller includes a hub and a plurality of blades disposed around an outer wall of the hub. Each of the blades has a leading edge with a predetermined distance below the top of the hub and a trailing edge protruding from the bottom of the hub. A fan including the impeller is also provided.

### BACKGROUND OF THE INVENTION

1. Field of Invention

The invention relates to a fan and an impeller thereof and, in particular, to a fan and an impeller thereof having downward-shifted blades.

2. Related Art

With the high development of technologies, the requirements for the functions of the electronic products become more critical and complex. Accordingly, the number of electronic elements in the electronic product and the integration of the electronic elements are increased, which results in the growing demands for heat dissipation. In other words, the heat dissipation capability directly affects the reliability and lifetime of the electronic product.

Fan is commonly used as a heat dissipating device. In practice, the working area of the fan, which is the area that can provide proper airflow pressure and airflow quantity of the fan, is used to remove heat rather than the maximum airflow quantity or the maximum airflow pressure. If a user wants to enhance the performance of the fan in the working area, he or she must increase the rotation speed of the fan. However, this may cause louder noise and need increased power consumption.

With reference to FIG. 1, a conventional fan 1 includes a fan frame 11, an impeller 12 and a motor 13. The impeller 12 includes a hub 121 and a plurality of blades 122 disposed around the hub 121. The motor 13 is used to drive the impeller 12 to rotate. As shown in FIG. 1, the top edge of the impeller 12 and the top boundary of the fan frame 11 are almost at the same plane. When the fan 1 starts to rotate, the impeller 12 may move upwardly or have displacement due to the accompanying axial and centrifugal force. Thus, the blades 122 of the impeller 12 easily contact the case of the electronic product or other elements. In such a case, the fan 1 may be damaged, and the heat dissipating effect of the electronic product may be decreased.

Therefore, it is an important subject of the invention to provide a fan and an impeller thereof that can enhance the performance of the working area without increasing the rotation speed of the fan and can prevent the blades from contacting the electronic product or other elements.

### SUMMARY OF THE INVENTION

In view of the foregoing, the invention is to provide a fan and an impeller thereof that can enhance the performance of the working area without increasing the rotation speed of the fan and can prevent the blades from contacting the electronic product or other elements in an electronic system.

To achieve the above, an impeller of the invention includes a hub and a plurality of blades. The blades are disposed around the hub. Each blade has a leading edge with a predetermined distance below the top of the hub and a trailing edge protruding from the bottom of the hub.

To achieve the above, the invention also discloses a fan, which includes a fan frame, an impeller and a motor. In the invention, the fan frame includes a housing, a base and at least one supporting element. The base is connected to the housing by the supporting element. The impeller, which is disposed in the housing, includes a hub and a plurality of blades disposed around the hub. Each blade has a leading edge with a predetermined distance below the top of the hub and a trailing edge protruding from the bottom of the hub. The motor is disposed on the base and coupled to the impeller for driving it.

As mentioned above, each blade of the impeller has a leading edge with a predetermined distance below the top of the hub, so that when the fan is operated, a space formed among the housing, the blades and the hub can make airflow steadier to be expelled out of the blades. In this case, the airflow pressure and the airflow quantity in the working area are larger than those of the conventional fan. That is, the performance of the working area of the fan can be enhanced without increasing the rotation speed of the fan. Accordingly, the louder noise and the increased power consumption can be avoided, and the better heat dissipating effect can be achieved. Besides, since displaced downwardly, the blades of the impeller, which is raised due to the axial and centrifugal force, may not contact the electronic product or other elements, so as to prevent the malfunctions of the fan, such as being stuck.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional fan;

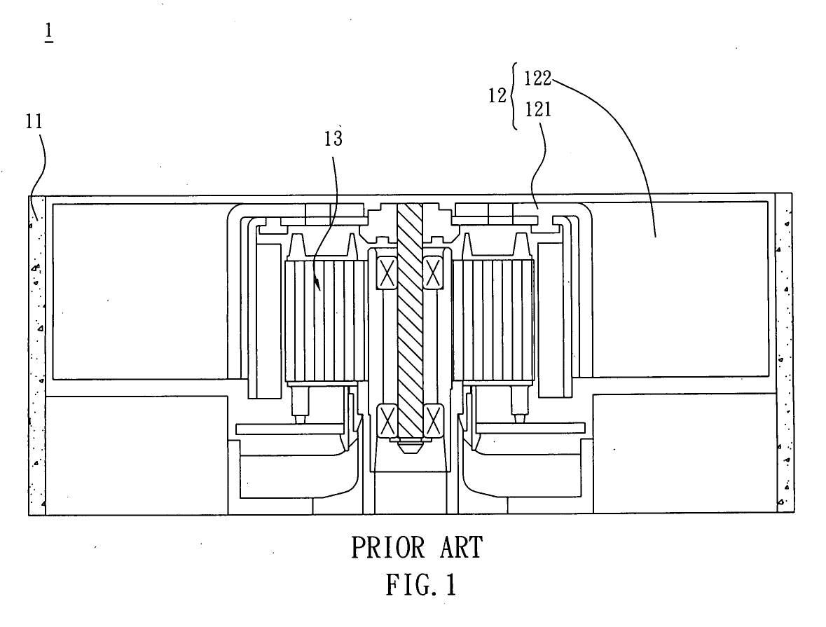

FIG. 2 is a schematic illustration showing an impeller according to a preferred embodiment of the invention;

FIG. 3 is a schematic illustration showing a fan according to the embodiment of the invention;

FIG. 4 is a schematic illustration showing another fan according to the embodiment of the invention;

FIG. 5 is a coordinate diagram showing the performances of the conventional fan and the fan of the present invention; and

FIG. 6 is a schematic illustration showing an impeller according to another embodiment of the invention.

### DETAILED DESCRIPTION OF THE INVENTION

The present invention will be apparent from the following detailed description, which proceeds with reference to the accompanying drawings, wherein the same references relate to the same elements.

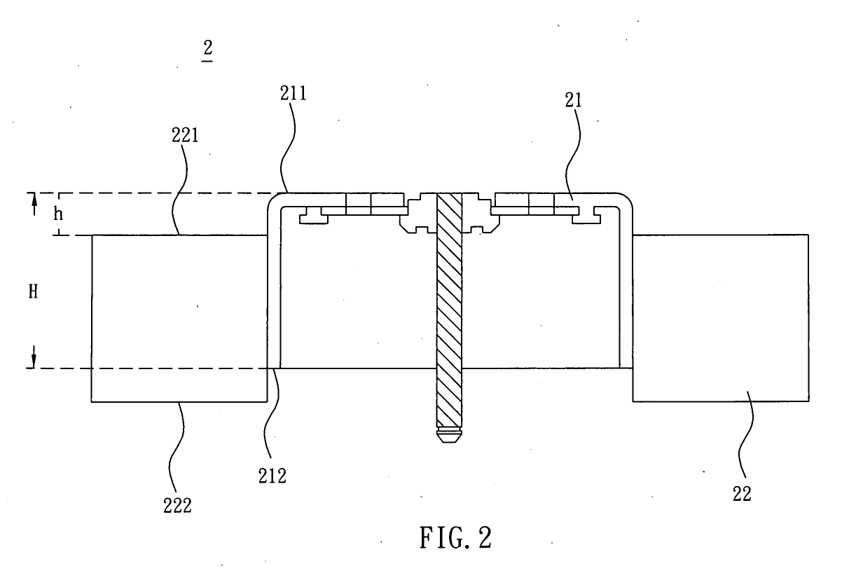

With reference to FIG. 2, an impeller 2 according to a preferred embodiment of the invention includes a hub 21 and a plurality of blades 22 disposed around the hub 21. The hub 21 and the blades 22 are integrally formed.

Each of the blades 22 has a leading edge 221 and a trailing edge 222. In this embodiment, the leading edge 221 and the trailing edge 222 are in parallel. The leading edge 221 has a predetermined distance h below the top 211 of the hub 21, and the trailing edge 222 protrudes from the bottom 212 of the hub 21. Accordingly, all of the blades 22 are moved downwardly. In the embodiment, the hub 21 and the blades 22 may be made of a plastic material, an acrylic material, a metal, or an alloy.

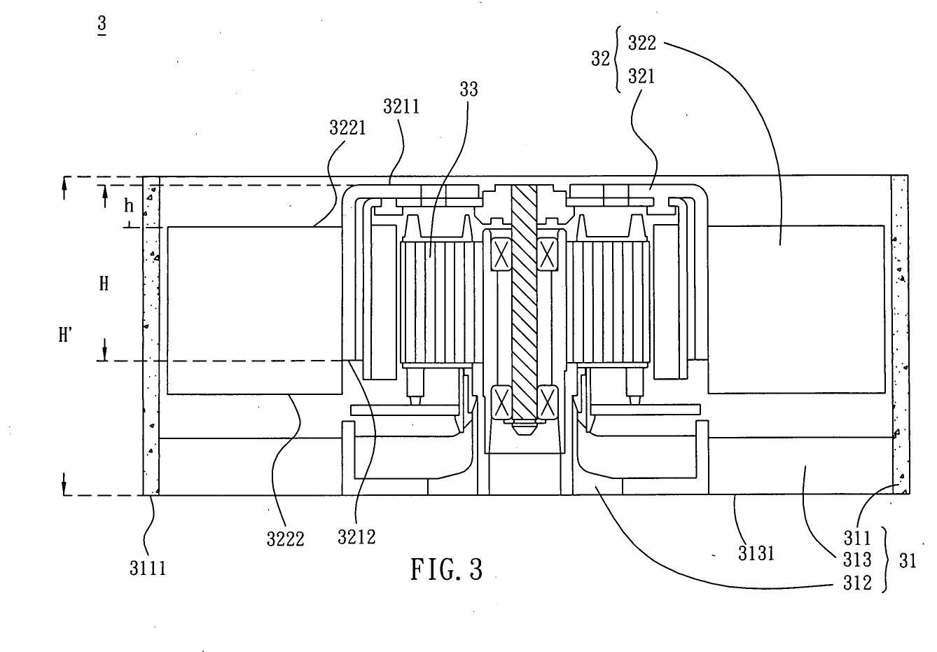

With reference to FIG. 3, a fan 3 according to the embodiment of the invention includes a fan frame 31, an impeller 32, and a motor 33. According to the concept of the invention, the type of the fan 3 is not limited, and it is an axial-flow fan in this embodiment.

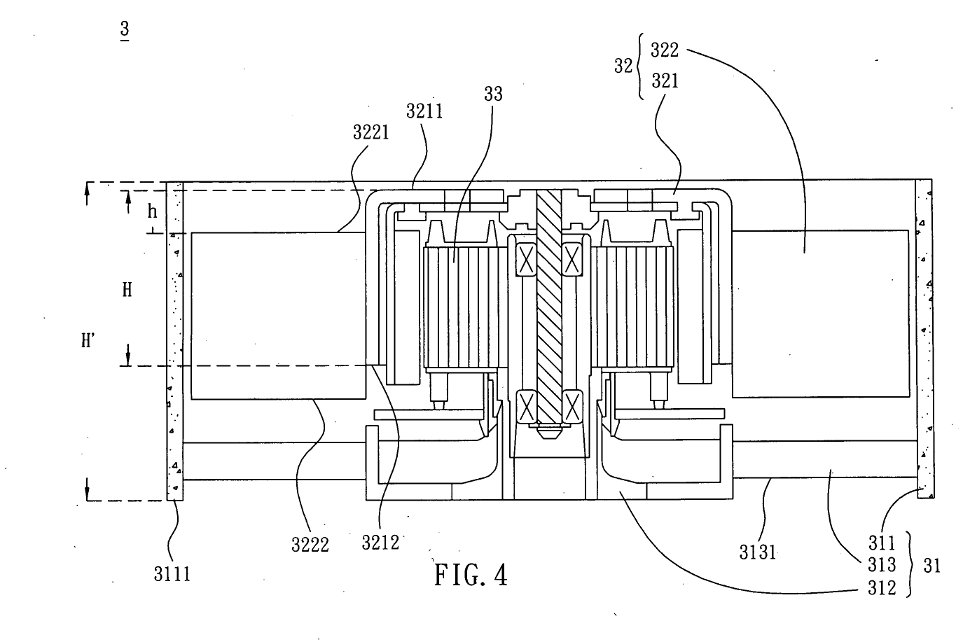

The fan frame 31 has a housing 311, a base 312 and at least one supporting element 313. The supporting element 313 is, for example, a rib or a stationary blade, and the base 312 is connected to the housing 311 by the supporting element 313. In this case, the housing 311, base 312 and supporting element 313 are integrally formed, and the bottom 3131 of the supporting element 313 and the bottom 3111 of the housing 311 are placed at the same plane. Of course, the bottom 3131 of the supporting element 313 and the bottom 3111 of the housing 311 may be placed at different planes. For instance, the bottom 3131 of the supporting element 313 may be shifted toward the interior of the housing 311 as shown in FIG. 4. To be noted, the position of the supporting element 313 has to be limited to such that it cannot interrupt or affect the rotation of the impeller 32. The housing 311, base 312 and supporting element 313 are made of, for example and not limited to, a plastic material, an acrylic material, a metal, or an alloy.

The impeller 32 is disposed in the housing 311 and supported by the base 312. In addition, the impeller 32 includes a hub 321 and a plurality of blades 322 disposed around the hub 321. The hub 321 and the blades 322 are integrally formed. Herein, the materials of the hub 321 and the blades 322 are not limited, and they may be made of a plastic material, an acrylic material, a metal, or an alloy. The motor 33 is disposed on the base 312 and coupled to the impeller 32 for driving it to rotate.

Each of the blades 322 has a leading edge 3221 and a trailing edge 3222. In this embodiment, the leading edge 3221 and the trailing edge 3222 are in parallel. The leading edge 3221 has a predetermined distance h below the top 3211 of the hub 321. In the embodiment, the predetermined distance h is preferably between 15% and 22.5% of the height H of the hub 321. In addition, the predetermined distance h is also preferably between approximately 8% and 12% of the height H′ of the housing 311. The trailing edge 3222 protrudes from the bottom 3212 of the hub 321. The protruding height of the trailing edge 3222 is approximately equal to the predetermined distance h, so that the blades 322 are substantially moved downwardly. Due to the provided distance h, the housing 311, the blades 322 and the hub 321 can define a space. When the fan 3 is operated, the flowing air becomes a steady airflow in this space. Accordingly, the performance of the working area of the fan 3 can be enhanced; that is, the airflow pressure and the airflow quantity in the working area become larger than those of the conventional fan.

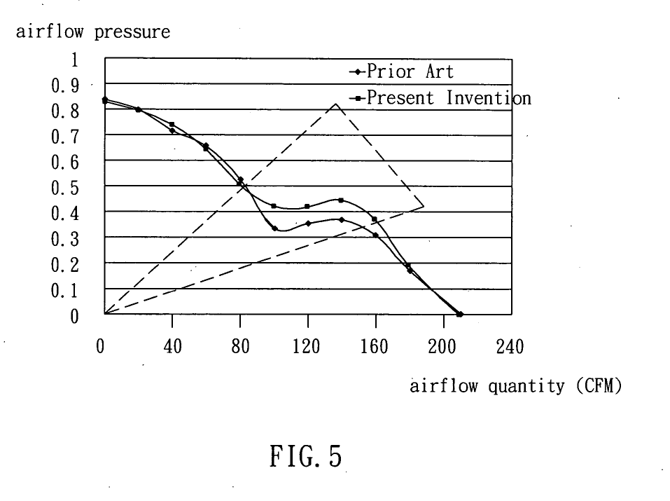

FIG. 5 is a coordinate diagram showing the performances of the conventional fan and the fan of the invention. As shown in FIG. 5, the X axis represents the airflow quantity, and the Y axis represents the airflow pressure. The triangular area represents the working area of the fans. Under the rotation speed of 4500 RPM, the experimental data of the FIG. 5 show that the fan of the invention can efficiently increase the airflow pressure. As a result, the performance of the fan of the invention is better than that of the conventional fan.

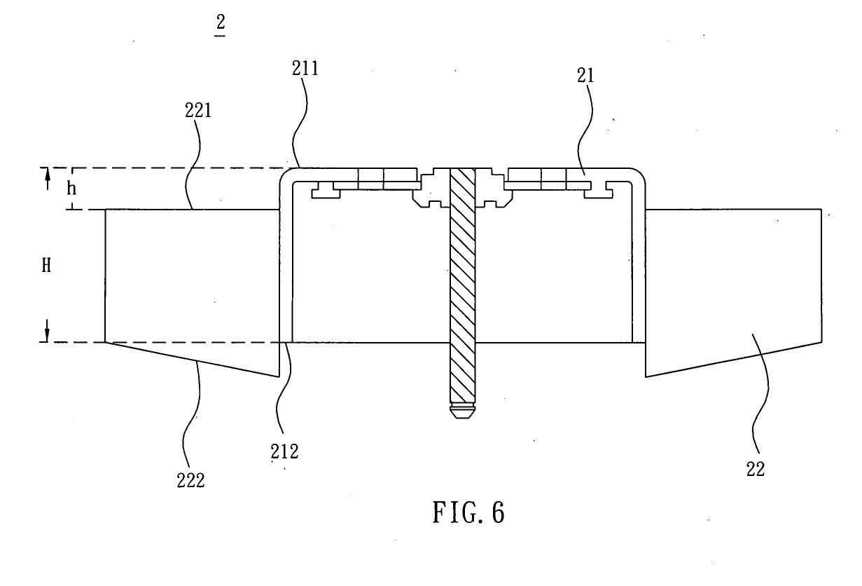

To be noted, the blades of the impeller are unnecessary to have the leading edge 221 and the trailing edge 222 in parallel (as shown in FIG. 2). The blades 22 may have the trailing edge 222 with a gradually raising slope from the inner edge to the outer edge thereof (as shown in FIG. 6). Of course, the blades 22 may have the trailing edge 222 with a gradually descending slope from the inner edge to the outer edge thereof (not shown).

In summary, each blade of the impeller has a leading edge with a predetermined distance below the top of the hub, so that a space can be formed among the housing, the blades and the hub. When the fan is operated, the flowing air becomes a steady airflow in this space and is then blown out of the blades. In this case, the airflow pressure and the airflow quantity in the operating area are larger. That is, the performance of the working area of the fan can be enhanced without increasing the rotation speed of the fan. Accordingly, the louder noise and the increased power consumption can be avoided, and the better heat dissipating effect can be achieved Besides, since displaced downwardly, the blades of the impeller, which is raised due to the axial and centrifugal force, may not contact electronic product or other elements to avoid the malfunctions of the fan, such as being stuck.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An impeller comprising:
a hub; and
a plurality of blades disposed around the hub, wherein each of the blades has a leading edge with a predetermined distance below the top of the hub and a trailing edge protruding from the bottom of the hub.

2. The impeller of claim 1, wherein the hub and the blades are integrally formed and made of a plastic material, an acrylic material, a metal, or an alloy.

3. The impeller of claim 1, wherein the blades have plate structures.

4. The impeller of claim 1, wherein the trailing edge of the blade is gradually raising or descending from an inner edge to an outer edge thereof.

5. The impeller of claim 1, wherein the leading edge of the blade and the trailing edge of the blade are in parallel or in non-parallel.

6. The impeller of claim 1, wherein the predetermined distance is approximately 15% to 22.5% of the height of the hub.

7. A fan comprising:
a fan frame having a housing, a base and at least one supporting element, wherein the base is connected to the housing by the supporting element;
an impeller disposed in the housing, wherein the impeller comprises a hub and a plurality of blades disposed around the hub, and each of the blades has a leading edge with a predetermined distance below the top of the hub and a trailing edge protruding from the bottom of the hub; and
a motor disposed on the base and coupled to the impeller for driving the impeller.

8. The fan of claim 7, wherein the housing, the base and the supporting element are integrally formed.

9. The fan of claim 7, wherein the housing, the base and the supporting element are made of a plastic material, an acrylic material, a metal, or an alloy.

10. The fan of claim 7, wherein the hub and the blades are integrally formed and made of a plastic material, an acrylic material, a metal, or an alloy.

11. The fan of claim 7, wherein the blades have plate structures.

12. The fan of claim 7, wherein the trailing edge of the blade is gradually raising or descending from an inner edge to an outer edge thereof.

13. The fan of claim 7, wherein the leading edge of the blade and the trailing edge of the blade are in parallel or in non-parallel.

14. The fan of claim 7, wherein the predetermined distance is approximately 15% to 22.5% of the height of the hub.

15. The fan of claim 7, wherein the predetermined distance is approximately 8% to 12% of the height of the housing.

16. The fan of claim 7, wherein the fan is an axial-flow fan.

17. The fan of claim 7, wherein the supporting element is a rib or a stationary blade.

18. The fan of claim 7, wherein the bottom of the supporting element and the bottom of the housing are placed at the same plane.

19. The fan of claim 7, wherein the bottom of the supporting element and the bottom of the housing are placed at different planes.

20. The fan of claim 19, wherein the bottom of the supporting element is shifted toward the interior of the housing.
